(19) United States
(12) Patent Application Publication
(10) Pub. No.: US 2003/0234172 A1
(43) Pub. Date: Dec. 25, 2003

(54) Method of facilitating a chemical reaction by applying radio frequency energy

(76) Inventors: Alan R. Arthur, Salem, OR (US); Ravi Prasad, Corvallis, OR (US); John A. Devos, Corvallis, OR (US); Philip Harding, Albany, OR (US)

Correspondence Address: HEWLETT-PACKARD COMPANY, Intellectual Property Administration, P.O. Box 272400, Fort Collins, CO, 80527-2400, US

(21) Appl. No.: 10/180,276

(22) Filed: Jun. 25, 2002

(51) Int. Cl. C01B 3/00; B01J 19/08; H01M 8/00

(52) U.S. Cl. 204/157.15; 423/648.1; 422/186; 422/186.29; 204/157.52; 429/12

(57) ABSTRACT

A fuel cell cartridge including a thermally-initiated hydrogen fuel source where the fuel cell cartridge is configured to receive radio frequency energy for thermally initiating the fuel source to produce hydrogen gas.

### FIELD OF THE INVENTION

This invention relates a method of facilitating a chemical reaction by applying radio frequency energy.

### BACKGROUND OF THE INVENTION

Over the past century the demand for energy has grown exponentially. With the growing demand for energy, many different energy sources have been explored and developed. One of the primary sources for energy has been and continues to be the combustion of hydrocarbons. However, the combustion of hydrocarbons usually results in incomplete combustion and non-combustibles that contribute to smog and other pollutants in varying amounts.

As a result of the pollutants created by the combustion of hydrocarbons, the desire for cleaner energy sources has increased in more recent years. With the increased interest in cleaner energy sources, fuel cells have become more popular and more sophisticated. Research and development on fuel cells has continued to the point where many speculate that fuel cells will soon compete with the gas turbine generating large amounts of electricity for cities, the internal combustion engine powering automobiles, and batteries that run a variety of small and large electronics.

Fuel cells conduct an electrochemical energy conversion of hydrogen and oxygen into electricity and heat. Fuel cells are similar to batteries, but they can be “recharged” while providing power.

Fuel cells provide a DC (direct current) voltage that may be used to power motors, lights, or any number of electrical appliances. There are several different types of fuel cells, each using a different chemistry. Fuel cells are usually classified by the type of electrolyte used. The fuel cell types are generally categorized into one of five groups: proton exchange membrane (PEM) fuel cells, alkaline fuel cells (AFC), phosphoric-acid fuel cells (PAFC), solid oxide fuel cells (SOFC), and molten carbonate fuel cells (MCFC).

PEM Fuel Cells

The PEM fuel cells are currently believed to be the most promising fuel cell technology, and use one of the simplest reactions of any fuel cell. Referring to FIG. 1, a PEM fuel cell will typically include four basic elements: an anode (20), a cathode (22), an electrolyte (PEM) (24), and a catalyst (26) arranged on each side of the electolyte (24).

Anode (20) is the negative post of the fuel cell and conducts electrons that are freed from hydrogen molecules such that the electrons can be used in an external circuit (21). Anode (20) includes channels (28) etched therein to disperse the hydrogen gas as evenly as possible over the surface of catalyst (26).

Cathode (22) is the positive post of the fuel cell, and has channels (30) etched therein to evenly distribute oxygen (usually air) to the surface of catalyst (26). Cathode (22) also conducts the electrons back from the external circuit to the catalyst, where they can recombine with the hydrogen ions and oxygen to form water. Water is the only by-product of the PEM fuel cell.

The electrolyte (24) is the proton exchange membrane (PEM) (24). The PEM is a specially treated porous material that conducts only positively charged ions. PEM (24) prevents the passage of electrons.

Catalyst (26) is typically a platinum powder thinly coated onto carbon paper or cloth. Catalyst (26) is usually rough and porous so as to maximize the surface area of the platinum that can be exposed to the hydrogen or oxygen. Catalyst (26) facilitates the reaction of oxygen and hydrogen.

In a working fuel cell, PEM (24) is sandwiched between anode (20) and cathode (22). The operation of the fuel cell can be described generally as follows. Pressurized hydrogen gas (H₂) enters the fuel cell on the anode (20) side. When an H₂ molecule comes into contact with the platinum on catalyst (26), it splits into two H⁺ ions and two electrons (e⁻). The electrons are conducted through the anode (20), where they make their way through external circuit (21) that may be providing power to do useful work (such as turning a motor or lighting a bulb (23)) and return to the cathode side of the fuel cell.

Meanwhile, on the cathode (22) side of the fuel cell, oxygen gas (O₂) is being forced through the catalyst (26). In some PEM fuel cell systems the O₂ source may be air. As O₂ is forced through the catalyst (26), it forms two oxygen atoms, each having a strong negative charge. This negative charge attracts the two H⁺ ions through the PEM (24), where they combine with an oxygen atom and two of the electrons from the external circuit to form a water molecule (H₂O).

The PEM fuel cell reaction just described produces only about 0.7 volts, therefore, to raise the voltage to a more useful level, many separate fuel cells are often combined to form a fuel cell stack.

PEM fuel cells typically operate at fairly low temperatures (about 80° C./176° F.), which allows them to warm up quickly and to be housed in inexpensive containment structures because they do not need any special materials capable of withstanding the high temperatures normally associated with electricity production.

Hydrogen Generation for Fuel Cells

As discussed above, each of the fuel cells described uses oxygen and hydrogen to produce electricity. The oxygen required for a fuel cell is usually supplied by the air. In fact, for the PEM fuel cell, ordinary air is pumped into the cathode. However, hydrogen is not as readily available as oxygen.

Hydrogen is difficult to generate, store and distribute. One common method for producing hydrogen for fuel cells is the use of a reformer. A reformer turns hydrocarbons or alcohol fuels into hydrogen, which is then fed to the fuel cell. Unfortunately, reformers are problematic. If the hydrocarbon fuel is gasoline or some of the other common hydrocarbons, SOₓ, NOₓ and other undesirable products are created. Sulfur, in particular, must be removed or it can damage the electrode catalyst. Reformers usually operate at high temperatures as well, which consumes much of the energy of the feedstock material.

Hydrogen may also be created by low temperature chemical reactions utilizing a fuel source in the presence of a catalyst. However, many problems are associated with low temperature chemical reactions for producing hydrogen. One of the primary problems is requirement for pumps to move the chemical mixture into a reaction chamber filled with a catalytic agent. As soon as the chemical mixture is exposed to a catalyst, the reaction rate is accelerated. Thus, the chemical mixture and catalyst must currently be separated until the products of the reaction are ready for consumption or storage. The use of a catalyst also introduces reliability concerns due to post reaction by-products that may contaminate the active catalyst surface. Temperatures in a catalytic reaction may also be difficult to control.

There has been some use of resistive heating of chemical mixtures that release hydrogen and other products at certain temperatures, but current methods either require multiple resistive heaters that are in contact with the chemical mixtures or pumping the chemical mixture into a heating chamber. Resistive heaters add expenses and electrical connections to the reaction chamber, and pumping adds the complexity of pumping equipment in addition to raising concerns about removal of post reaction by-products which may adversely affect reliability of the plumbing and reaction chamber. Pumps add to the parasitic losses of the power generation process as well. In addition, heating by resistive elements is prone to problems with conduction resulting in localized hot spots.

### SUMMARY OF THE INVENTION

The present invention provides, among other things, a fuel cell cartridge including a thermally-initiated hydrogen fuel source where the fuel cell cartridge is configured to receive radio frequency energy for thermally initiating the fuel source to produce hydrogen gas.

### BRIEF DESCRIPTION OF THE DRAWINGS

The foregoing and other features and aspects of the invention will become further apparent upon reading the following detailed description and upon reference to the drawings in which:

FIG. 1 is an unassembled perspective view of a PEM fuel cell apparatus.

FIG. 2 is a diagrammatical illustration of a chemical mixture heating system according to one embodiment of the present invention.

FIG. 3 is a diagrammatical illustration of a radio frequency heating system according to one aspect of the present invention.

FIG. 4 is perspective view of a chemical mixture heating cartridge according to one embodiment of the present invention.

FIG. 5 is a perspective view of another chemical mixture heating apparatus according to one aspect of the present invention.

FIG. 6 is a cut-away view of a chemical mixture heating apparatus according to one aspect of the present invention.

FIG. 7 is a cut-away view of a chemical mixture heating apparatus according to another aspect of the present invention.

In the drawings, identical reference numbers indicate similar, but not necessarily identical, elements. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF ILLUSTRATED EMBODIMENTS

Illustrative embodiments of the invention are described below. As will be appreciated by those skilled in the art, the present invention can be implemented in a wide variety of chemical reactions including those for producing hydrogen for fuel cells. The fuel cell applications include, but are not limited to, PEM fuel cells, AFCs, PAFCs, SOFCs, and MCFCs.

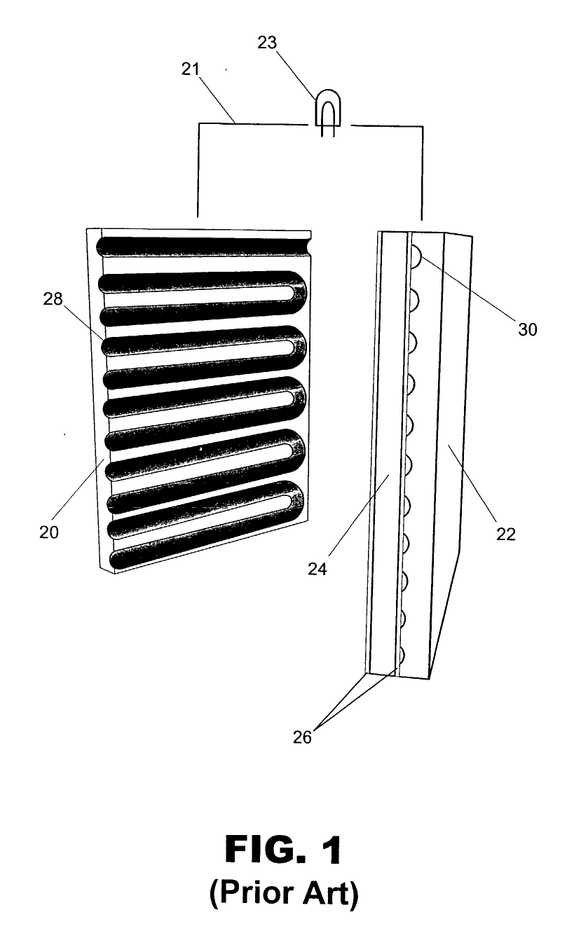

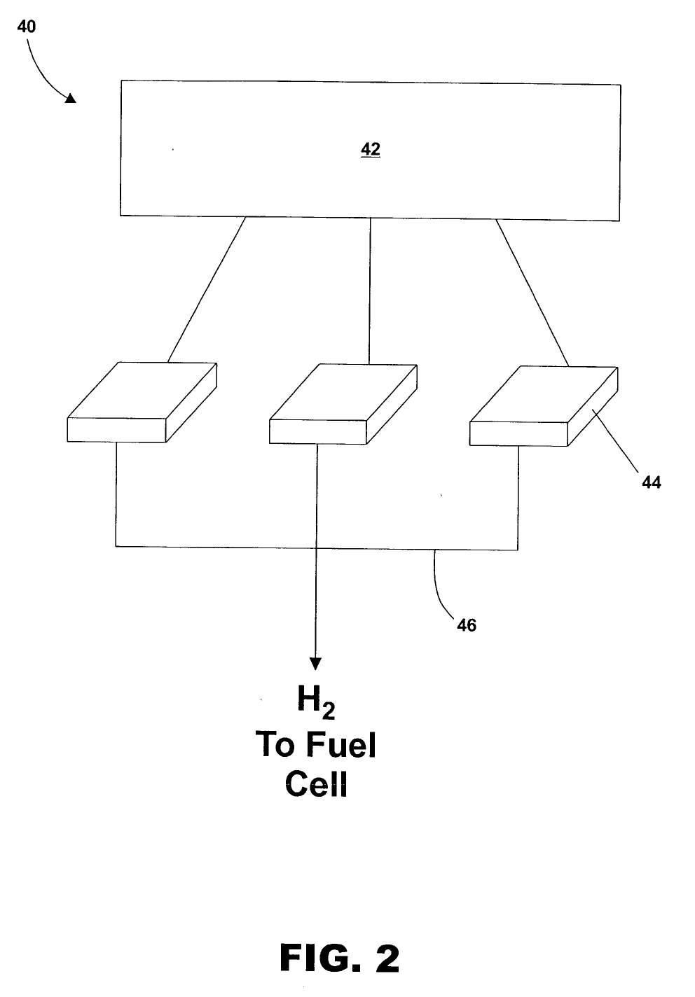

Turning now to the figures, and in particular to FIG. 2, a chemical mixture heating system, for example a hydrogen generating system (40), is shown according to one embodiment of the present invention. The hydrogen generating system (40) is shown in FIG. 2 in a diagrammatical format. According to the embodiment of FIG. 2, the hydrogen generating system (40) may include a radio frequency (RF) generation system (42) and one or more chemical mixtures arranged in chambers, for example chemical mixture pods (44). The hydrogen generating system (40) may also include a gas generation path, which, in the present embodiment, is shown as a gas manifold (46). Gas generated from chemical mixtures contained by the chemical mixture pods (44) may travel through the gas manifold (46) and, if the gas generated is hydrogen, be delivered to a fuel cell such as the PEM fuel cell shown in FIG. 1.

As discussed in the background above, production of hydrogen for consumption by a fuel cell can be a specialized process and often a high-temperature process. However, because fuel cells are capable of operation at relatively low temperatures, it is desirable in some circumstances to also produce the hydrogen gas used by a fuel cell at low temperatures. A low temperature fuel cell that may be supplied with hydrogen by a low temperature production source can advantageously be used in many power consumption situations with little residual heat and fewer specialized materials capable of operating at high temperatures. Accordingly, the present invention includes the RF generating system (42) to facilitate the production of hydrogen or other products from chemical mixtures at relatively low temperatures (often below about 100° C.).

Some chemical mixtures for producing hydrogen are thermally-initiated fuels. Thermally-initiated fuels include mixtures that release a useful fuel gas such as hydrogen at certain elevated temperatures. Most often, a thermally-initiated fuel must be raised to a temperature above the ambient conditions to release a useful amount of the fuel gas. As discussed above, there has been some use of resistive heating elements to increase the temperature of certain thermally-initiated fuels to create fuel gases such as hydrogen, but resistive heating elements are prone to local hot spots and require additional electrical connections. Therefore, according to the embodiment of FIG. 2, the RF generating system (42) is provided to heat a thermally-initiated fuel or other chemical mixture contained in the chemical mixture pods (44).

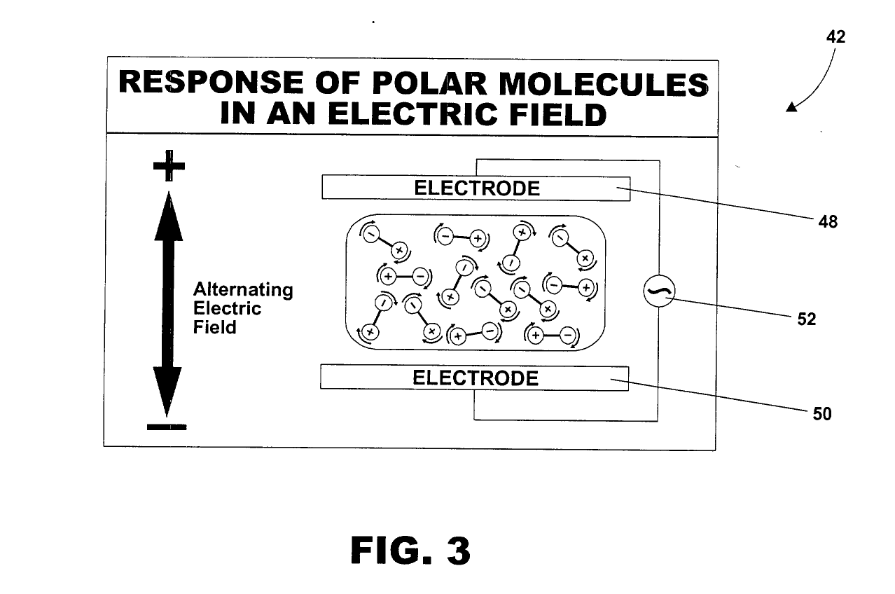

The operation of the RF generating system (42) may be explained with reference to FIG. 3. It will be recognized by those of skill in the art with the benefit of this disclosure that radio frequency energy is electromagnetic radiation comprising waves of electric and magnetic energy moving together (i.e., radiating) through space at the speed of light. Taken together, all forms of electromagnetic energy are referred to as the electromagnetic “spectrum.” Radio waves and microwaves emitted by transmitting antennas are forms of electromagnetic energy. They are collectively referred to as “radio frequency” or “RF” energy or radiation. The term “electromagnetic field” or “radio frequency field” may be used to indicate the presence of electromagnetic or RF energy.

The RF waves emanating from antennae (48 and 50) according to the embodiment of FIG. 3 are generated by the movement of electrical charges in the antennae as induced by an oscillator (52). Electromagnetic waves may be characterized by a wavelength and a frequency. The wavelength is the distance covered by one complete cycle of the electromagnetic wave, while the frequency is the number of electromagnetic waves passing a given point in one second. The frequency of an RF signal is usually expressed in terms of a unit called the “hertz” (Hz). One Hz equals one cycle per second. One megahertz (MHz) equals one million cycles per second.

Different forms of electromagnetic energy are categorized by their wavelengths and frequencies. The RF part of the electromagnetic spectrum is generally defined as that part of the spectrum where electromagnetic waves have frequencies in the range of about three kilohertz (3 kHz) to three hundred gigahertz (300 GHz). Therefore, for purposes of this disclosure, RF energy is defined to be in the range of about three kHz to about three hundred GHz. Microwaves are a specific category of radio frequency waves that will be defined as radio frequency energy where frequencies range from several hundred MHz to several GHz.

As shown in FIG. 3, the antennae (48 and 50) may be operatively connected to the RF oscillator (52). The RF oscillator (52) and the antennae (48 and 50) are commercially available from a myriad of sources. In some embodiments of the present invention, the RF oscillator (52) is further defined to be a microwave oscillator, which is a subset of RF.

When energized, the antennae (48 and 50), in combination with the RF oscillator (52), provide RF energy used in the present invention to heat chemical mixtures in the pods (44). According to the arrangement of the RF generating system (42), the RF oscillator (52) may create an alternating electric field between the two antennae (48 and 50). The material to be heated (in the present embodiment a thermally-initiated fuel in pods (44; FIG. 2)) is conveyed between the antennae (48 and 50) where the alternating energy causes polar molecules in the material to continuously reorient themselves to face opposite poles much like the way bar magnets behave in an alternating magnetic field. The friction resulting from molecular movement causes the material to rapidly heat throughout its entire mass. Polar molecules within the material are represented by the spheres with + and − signs connected by bars. The very rapid and precisely controllable RF heating process offers the advantages of reduced processing times, consistent heating, and simplified process control over other heating methods such as resistive heating elements.

The amount of heat generated in the material is determined by the frequency, the applied voltage, the dimensions of the product, and the dielectric loss factor of the material which is essentially a measure of the ease with which the material can be heated by radio frequency waves.

Returning to FIG. 2, as RF energy is applied by the RF generating system (42) to the thermally-initiated fuel in the chemical mixture pods (44; FIG. 2), the temperature of the thermally-initiated fuel rises. This may occur by applying RF energy to excite the water molecules of an aqueous solution or by using an RF coupling agent mixed with a chemical solution and exciting the RF coupling agent molecules. RF coupling agents may include, but are not limited to water and similar polar molecules. The rise in temperature of the thermally-initiated fuel will eventually cause a fuel gas such as hydrogen to be produced. In some embodiments, the thermally-initiated fuel is an aqueous metal hydride such as sodium borohydride, but other thermally-initiated fuels including, but not limited to, amine boranes and other solutions may also be used. In embodiments where the thermally-initiated fuel is an aqueous metal hydride, the temperature may be raised to a thermal decomposition temperature, at which hydrogen is rapidly released from the solution and may be directed to a fuel cell.

In embodiments where the chemical mixture in the chemical mixture pods (44; FIG. 2) is a thermally-initiated fuel such as sodium borohydride, the produced hydrogen gas may be provided to a fuel cell. However, other products may also be made and directed in ways other than sending the gas through manifold (46; FIG. 2) to a fuel cell. For example, the products may be collected and stored in a tank.

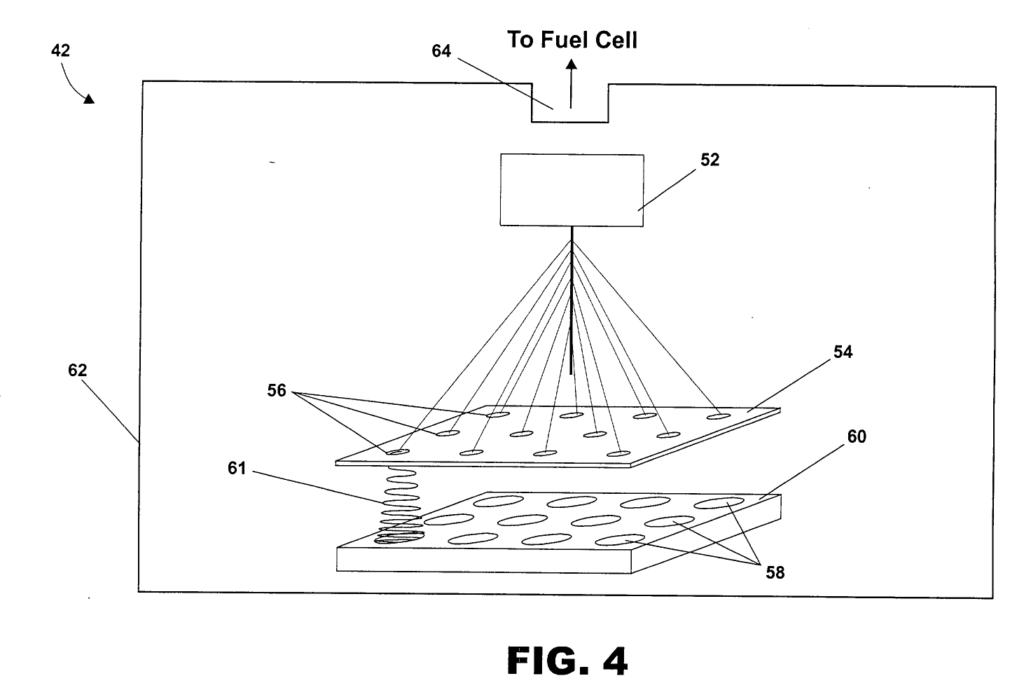

Turning next to FIG. 4, an embodiment of a heating system according to the present invention is shown. According to the embodiment of FIG. 4, an RF oscillator (52) may be operatively attached to an antenna array (54) comprising multiple antennae (56). Additionally, depending on the frequency used and power levels involved, the antennae array (54) may also be replaced with opposing electrodes (not shown). These electrodes may have at least two possible arrangements. The first may be a sandwich structure with electrodes on each side of the chemical pods (58). The second may be a side-by-side arrangement. The side-by-side arrangement may provide a simpler structure with respect to packaging than the first structure, however, it may suffer from less effective energy distribution.

Antennae array (54) may comprise a printed circuit board or other multiple antennae (56) arrangement. Each of the multiple antennae (56) may be individually controlled by the RF oscillator (52) in some embodiments, however, this is not necessarily so. Each of the multiple antennae (56) may also be collectively activated and deactivated by the RF oscillator (52).

According to the embodiment of FIG. 4, each of the multiple antennae (56) is associated with a chamber such as one of the chemical pods (58) shown disposed in a tray (60). The chemical pods (58) may be cylindrical in shape as shown in the figure, but other shapes may also be used. Chemical mixtures contained by the chemical pods (58) may be selectively heated by the application of RF energy to facilitate the production of products such as hydrogen from an aqueous mixture of metal hydride. A representation of generated energy waves (61) is shown to demonstrate the application of RF energy from one of the multiple antennae (56) to an associated chemical pod (58).

As mentioned above, according to some embodiments of the present invention, hydrogen may be generated by heating chemical mixtures such as sodium borohydride. Therefore, according to the embodiment of FIG. 4, the hydrogen cartridge (62) may provide a supply of hydrogen to a fuel cell. The hydrogen cartridge (62) may be arranged with chemical pods (58) in intimate proximity to the antennae array (54) when the hydrogen cartridge (62) is loaded into a fuel cell apparatus. The RF oscillator (52) and the antennae array (54) for directing energy to the chemical pods (58) containing aqueous sodium borohydride (or another thermally-initiated hydrogen producing mixture) may be separate from the hydrogen cartridge (62) as part of a fuel cell power architecture. Alternatively, the RF oscillator (52) and the antennae array (54) may be integral with the hydrogen cartridge (62).

Hydrogen produced in the cartridge (62) by the heating the aqueous sodium borohydride may exit the cartridge through a port (64). The port (64) may lead to a supply line (not shown) of a fuel cell. The cartridge (62) may be configured in any convenient arrangement to engage a fuel cell and provide a supply of energy on demand by placement of the cartridge (62) in proximity to the selectively operational RF generating system to provide controlled release of hydrogen gas to the fuel cell.

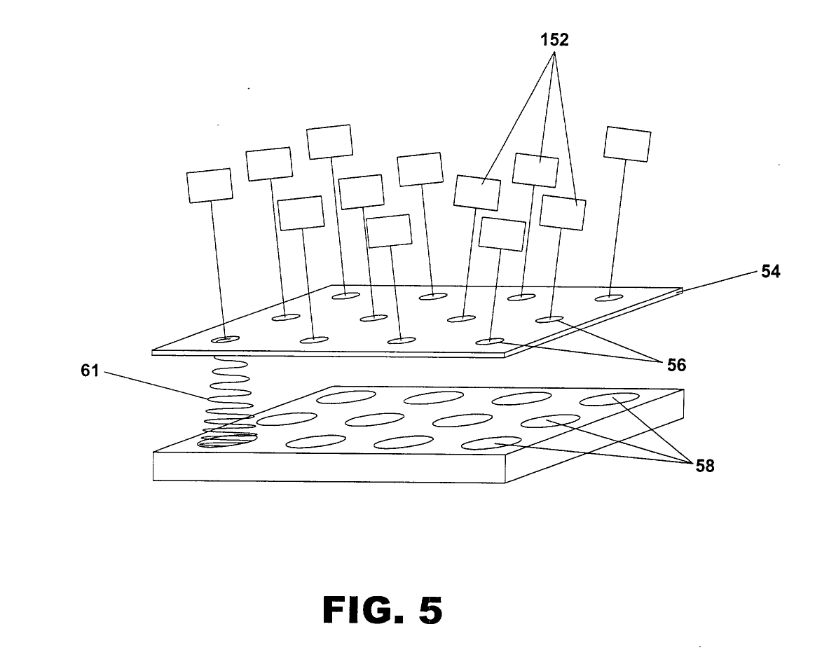

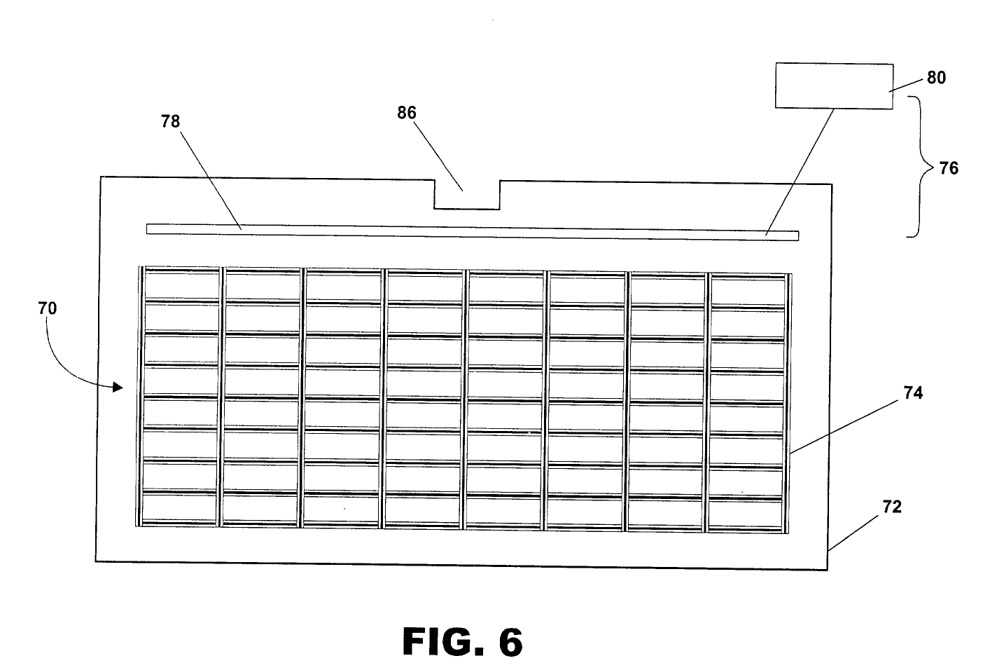

Turning next to FIG. 5, another embodiment of a heating system according to the present invention is shown. The embodiment of FIG. 5 is similar to that of FIG. 4, however, multiple oscillators (152) are included. According to the embodiment of FIG. 5, each of the multiple antennae (56) has its own oscillator to add more control to the antenna array (54). However, in some embodiments each of multiple oscillators (152) may control two or more of the antennae (56). The addition of multiple oscillators (152) as shown in FIG. 6 may facilitate the independent activation of one or more chemical mixtures disposed in chemical pods (58) more easily than might be possible with a single oscillator.

Turning next to FIG. 6, another embodiment of a heating system according to the present invention is shown. As discussed above, another way to promote low-temperature production of fuel gases such as hydrogen from a chemical mixture such as aqueous metal hydrides or other hydrogen-bearing mixtures is to expose the chemical mixture to a catalyst. Catalysts that may be useful in the production of hydrogen may include, but are not limited to ruthenium, platinum, nickel, and other catalysts that are readily available to those of skill in the art having the benefit of this disclosure. Catalysts are often very expensive and are most effective when a maximum surface area is exposed to the reactants. To provide maximum surface area for the catalyst, the catalysts can be arranged in many configurations, including a catalyst-plated, high surface area screen (70) that may be rolled and inserted into a reaction chamber (72). Catalyst-plated, high surface area screen (70) advantageously provides a structure that is not easily rearranged in the presence of reactants and products within the reaction chamber (72). Therefore, the catalyst material continues to have a very high surface area exposed to the chemical reactants to maximize the reaction rate and thus the production of fuel gases such as hydrogen produced from, for example, sodium borohydride.

The catalyst distribution structure may also include multiple catalyst-plated, high surface area mesh strips. The strips (appearing like screen (70) which is shown only in a one-dimensional view) may be placed in the reaction chamber (72) in a manner similar to the high surface area screen (70). Alternatively, the catalyst distribution structure may include catalyst-coated, high surface area fibrous material.

Regardless of the implied or described catalyst structures mentioned above, the catalyst distribution structure or the catalyst itself may have a material set and geometry to promote RF heating. This material set and geometry may include, but is not limited to, electrically conductive materials with size and geometry to promote resistive heating of the catalyst. The resistive heating may be promoted by electron motion in the material as induced by impinging electromagnetic waves from an RF source (76). Such geometry may include, but not be limited to, low cross sectional area fibrous conductive material made of a catalyst or upon which the catalyst has been deposited.

According to the embodiment of FIG. 6, however, the catalyst plated screen (70) is itself coated in an outer coating (74). The outer coating (74) insulates the catalyst plated on the catalyst-plated screen (70) from the chemical mixture housed in the reaction chamber (72). Therefore, the chemical mixture is precluded from engaging the catalyst material directly by the outer coating (74). The outer coating (74) may comprise paraffin or other polymers having relatively low melting temperatures and that are generally non-reactive so as to prevent direct contact between chemical reactants and a catalyst such as the catalyst-plated screen (70). Low melting temperatures may include temperatures of less than about 100° C.

The outer coating (74) may be melted, however, by increasing the temperature of the outer coating (74) by heating polar constituents in the coating itself, or via heating the catalyst or its substrate using the mechanisms described above. Therefore, the heating system according to the embodiment of FIG. 6 may include an RF generating system (76) to facilitate the melting of outer coating (74) on demand. The RF generating system (76) may include an antenna (78) located within or outside of the reaction chamber (72) that is operatively connected to an oscillator (80). The combination of the antenna (78) and the oscillator (80) may be used to apply RF energy directly to the outer coating (74) or indirectly via the chemical mixture contained by the reaction chamber (72). When the temperature of the outer coating (74) reaches its melting point, the outer coating will melt and expose the chemical mixture contained by the reaction chamber (72) to the catalyst on the catalyst-plated screen (70). The exposure of the chemical mixture to the catalyst will then, in turn, tend to increase the rate of reaction of the chemical mixture. In embodiments where the chemical mixture is an aqueous metal hydride solution such as aqueous sodium borohydride, and the catalyst is a ruthenium catalyst, the rate of hydrogen gas production may be significantly increased by the exposure of the sodium borohydride to the ruthenium catalyst. Produced hydrogen gas may then be directed to a fuel cell for electrical power generation by transferring the produced hydrogen gas through a port (86) in the reaction chamber (72).

Thus, according to the principles of the present invention, a coated catalyst may be introduced to a chemical mixture and yet remain insulated from the chemical mixture for an indefinite period of time. The mixture may later be directly exposed to the catalyst by melting the coating (74) to facilitate the reaction of the chemical mixture. Previously, chemical mixtures and catalysts were contained in separate containers from one another prior to the actual need for the enhanced reaction. But, according to the present invention, a coated catalyst may be advantageously packaged with the chemical mixture and selectively exposed to the chemical mixture upon the application of RF energy to melt the coating. In addition, after the outer coating (74) has been melted and the catalyst-plated screen (70) exposed directly to the chemical mixture, RF energy may continue to be supplied to the chemical mixture to further enhance the production of the products such as hydrogen gas.

It will be understood by those of skill in the art having the benefit of this disclosure that the chemical mixture discussed above with reference to FIG. 6 may be compartmentalized in a configuration such as that shown in FIG. 2. In such embodiments, each compartment may contain a catalyst-plated screen (70) with an outer coating (74) as described above. Accordingly, the outer coating (74) of each compartmentalized portion of chemical mixture may be independently melted by the application of RF energy.

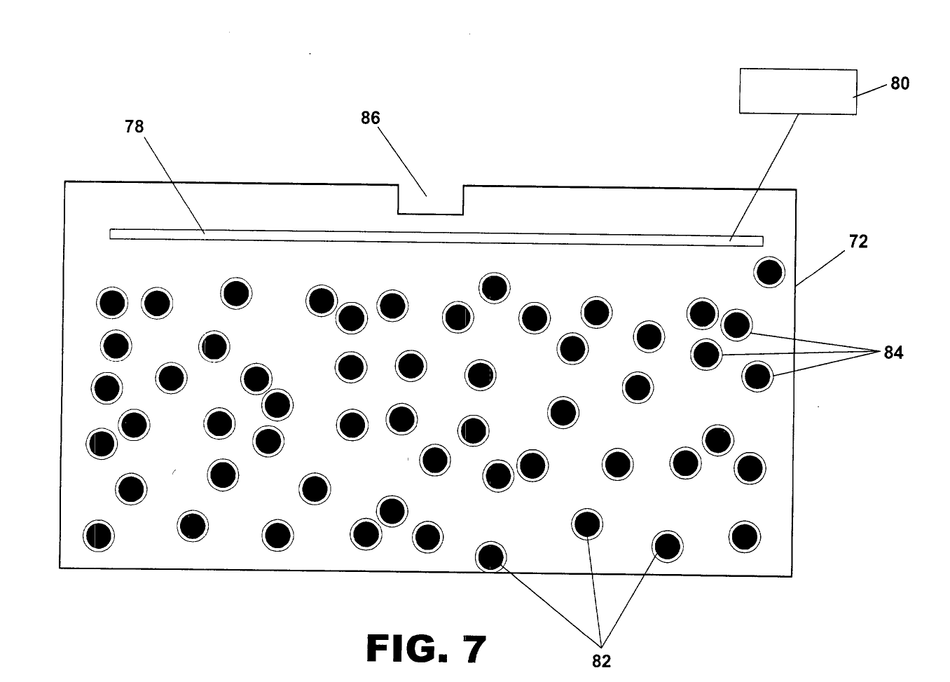

Turning next to FIG. 7, another heating system according to one embodiment of the present invention is shown. According to the embodiment of FIG. 7, the catalyst plated screen (70) shown in FIG. 6 is replaced by high surface area catalyst beads (82). The catalyst beads (82) may initially include a coating (84) similar to the outer coating (74) shown in FIG. 6. The coating (84) may include wax or other polymers having a low melting temperature. As with the outer coating (74) of the catalyst plated high surface area screen (70) shown in FIG. 6, the bead coating (84) may be melted when desired by applying RF energy to the bead coating (84) itself or the chemical mixture housed in the reaction chamber (72). Incorporating with the catalyst distribution structure or the catalyst itself a material set and geometry to promote resistive heating of the catalyst as described above may facilitate the heating and melting of the bead coating (84). RF energy may continue to be applied to the chemical mixture after the bead coating (84) has been melted to increase the temperature of the chemical mixture and enhance the production of hydrogen or other products.

The application of RF energy to the bead coating (84) or the chemical mixture housed in the reaction chamber (72) may be done in substantially the same manner as described with reference to FIG. 6. That is, the combination of the oscillator (80) and antenna (78) may be activated to generate and apply RF energy to the bead coating (84) and/or the chemical mixture housed in the reaction chamber (72).

The preceding description has been presented only to illustrate and describe the invention. It is not intended to be exhaustive or to limit the invention to any precise form disclosed. Many modifications and variations are possible in light of the above teaching.

The embodiments shown were chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A method of facilitating a chemical reaction comprising applying radio frequency energy to a fuel pod containing a chemical solution.

2. The method of claim 1, wherein said chemical solution comprises a thermally-initiated fuel source.

3. The method of claim 2, further comprising generating a fuel gas from said thermally-initiated fuel source.

4. The method of claim 3, further comprising raising the temperature of said thermally-initiated hydrogen fuel source to a hydrogen decomposition temperature by the application of said radio frequency energy.

5. The method of claim 4, wherein said thermally-initiated fuel comprises an aqeuous metal hydride and said fuel gas comprises hydrogen.

6. The method of claim 5, further comprising directing said hydrogen to a fuel cell.

7. The method of claim 4, wherein said thermally-initiated fuel comprises an amine borane.

8. The method of claim 1, wherein said radio frequency energy is in a microwave range.

9. The method of claim 1, wherein said fuel pod comprises a catalyst with a coating insulating said catalyst from said chemical solution.

10. The method of claim 9, further comprising raising the temperature of said coating to a coating melting temperature, wherein said catalyst is exposed directly to said chemical solution when said coating melts.

11. A method of hydrogen generation comprising applying radio frequency energy to a chemical mixture that releases hydrogen gas at a temperature greater than ambient.

12. The method of claim 11, further comprising separating said chemical mixture into chambers prior to applying said radio frequency energy.

13. The method of claim 12, further comprising selectively energizing one or more radio frequency antennae directed at said chambers.

14. The method of claim 11, further comprising raising the temperature of said chemical mixture by application of said radio frequency energy to a thermal decomposition of hydrogen temperature, and directing released hydrogen to a fuel cell.

15. The method of claim 11, further comprising tuning said radio frequency energy to a microwave range.

16. The method of claim 11, wherein said chemical mixture comprises an aqueous metal hydride.

17. The method of claim 16, wherein said aqueous metal hydride comprises sodium borohydride.

18. A method of producing hydrogen comprising applying radio frequency energy to a hydrogen-bearing chemical mixture in the presence of a catalyst, wherein said catalyst is at least partially covered by a coating.

19. The method of claim 18, further comprising raising the temperature of said chemical mixture to a melting point of said coating, wherein said catalyst is directly exposed to said hydrogen-bearing chemical mixture when said coating melts.

20. The method of claim 19, wherein said chemical mixture comprises an aqueous metal hydride.

21. A method of combining a chemical mixture with a catalyst comprising providing a coating for said catalyst such that said catalyst does not react in the presence of said chemical mixture while said coating is in tact, and raising the temperature of said coating to its melting point by application of radio frequency energy.

22. The method of claim 21, wherein said radio frequency energy is absorbed by said coating or heats a substrate over which said coating is applied.

23. A method of facilitating a chemical reaction comprising melting a non-reactive coating covering a catalyst by application of radio frequency energy.

24. The method of claim 23, wherein said radio frequency energy is absorbed by said non-reactive coating or heats a substrate over which said nonreactive coating is applied.

25. The method of claim 23, further comprising combining said catalyst having said non-reactive coating thereon with a chemical mixture prior to melting said non-reactive coating.

26. The method of claim 21, wherein said chemical mixture comprises an aqueous metal hydride.

27. The method of claim 26, further comprising directing hydrogen gas produced from said aqueous metal hydride to a fuel cell.

28. The method of claim 25, wherein said non-reactive coating comprises paraffin.

29. The method of claim 23, further comprising providing a catalyst distribution structure comprising a material set and geometry to promote radio frequency heating.

30. The method of claim 29, wherein said material set comprises electrically conductive materials that are induced to greater electron motion by impinging electromagnetic waves from said radio frequency energy.

31. The method of claim 23, wherein said catalyst comprises a material set and geometry to promote radio frequency heating.

32. The method of claim 31, wherein said material set comprises electrically conductive materials that are induced to greater electron motion by impinging electromagnetic waves from said radio frequency energy.

33. A chemical reactor apparatus comprising:
a chemical reaction chamber; and
a radio frequency energy source in proximity to said reaction chamber;
wherein radio frequency energy from said radio frequency energy source initiates a chemical mixture.

34. The apparatus of claim 33, wherein said chemical reaction chamber comprises a plurality of pods, each pod configured to hold a portion of said chemical mixture.

35. The apparatus of claim 34, wherein said chemical mixture comprises a thermally-initiated fuel.

36. The apparatus of claim 35, wherein said thermally-initiated fuel comprises an aqueous metal hydride for producing hydrogen gas.

37. The apparatus of claim 36, wherein said radio frequency energy source is activated and directed at said aqueous metal hydride to raise a temperature of said aqueous metal hydride to a thermal decomposition temperature.

38. The apparatus of claim 33, wherein said radio frequency energy source comprises an antenna and a radio frequency oscillator.

39. The apparatus of claim 38, wherein said radio frequency energy source comprises a plurality of selectively operational antennae.

40. The apparatus of claim 39, wherein each of said plurality of selectively operational antennae is directed at a pod of said chemical reaction chamber.

41. The apparatus of claim 33, wherein said chemical reactor is coupled to a fuel cell and provides hydrogen gas to said fuel cell.

42. A fuel cell cartridge comprising:
a thermally-initiated hydrogen fuel source;
wherein said fuel cell cartridge is configured to receive radio frequency energy for thermally initiating said fuel source to produce hydrogen gas.

43. The cartridge of claim 42, wherein said fuel source comprises sodium borohydride.

44. The cartridge of claim 42, wherein said fuel source comprises an amine borane.

45. The cartridge of claim 42, wherein said thermally-initiating fuel source is disposed in a plurality of pods, and wherein each of said plurality of pods has an associated radio frequency antenna.

46. The cartridge of claim 42, wherein said thermally activated fuel source is contained in a reactor in the presence of a catalyst, and wherein said catalyst is at least partially covered by a non-reactive coating.

47. The cartridge of claim 46, wherein said radio frequency energy is applied by an autonomous radio frequency energy source and is applied to heat said non-reactive coating beyond a melting point of said coating and expose said thermally activated fuel source directly to said catalyst.

48. The cartridge of claim 42, wherein said radio frequency energy is supplied by a radio frequency energy source integrated with said cartridge.

49. A chemical reactor apparatus comprising:
means for containing a hydrogen-producing chemical reaction; and
means for providing radio frequency energy to the containing means to initiate production of hydrogen.

50. The chemical reactor of claim 44, further comprising means for transferring said hydrogen to a fuel cell.

51. A catalyst for controllably facilitating a chemical reaction comprising a non-reactive coating for insulating said catalyst from a chemical mixture.

52. The catalyst of claim 51, wherein said non-reactive coating comprises a polymer with a melting temperature below about 100° C.

53. The catalyst of claim 51, wherein said polymer comprises paraffin.

54. The catalyst of claim 51, wherein said coating is melted by the application of radio frequency energy.

55. A fuel cell apparatus comprising:
an anode;
a cathode;
an electrolyte disposed between said anode and said cathode;
and a radio frequency energy source.

56. The fuel cell apparatus of claim 55, wherein said radio frequency energy source is directed at a hydrogen-bearing mixture for providing hydrogen gas to said anode.
